(19) United States
(12) Patent Application Publication
(10) Pub. No.: US 2002/0016207 A1
(43) Pub. Date: Feb. 7, 2002

(54) Torsionally elastic coupling

(76) Inventor: Matthias Geislinger, Salzburg (AT)

Correspondence Address: COLLARD & ROE, P.C., 1077 Northern Boulevard, Roslyn, NY, 11576-1696, US

(21) Appl. No.: 09/881,150

(22) Filed: Jun. 14, 2001

(30) Foreign Application Priority Data
Jun. 15, 2000 (AT) A 1030/2000

(51) Int. Cl. F16D 3/52; F16D 3/56; F16D 3/64; F16D 3/72; F16D 3/76; F16D 3/78

(52) U.S. Cl. 464/87

(57) ABSTRACT

A torsionally elastic coupling (1) is equipped with a plurality of radially deflectable springs (4) distributed over the periphery for transmission of torque between a hub (2) and an outer crown (3). In order to achieve simple torsionally elastic coupling with axial, radial and angular displacement capacity and having a vibration-damping effect, the springs (4) comprise a fiber-reinforced body (9) bent at least once about an axis of curvature (K) parallel to the axis of rotation (D) of the coupling and connecting elements (11, 12) for attaching the hub or outer crown, in which at least one longitudinally extending elastomer layer (13) is embedded between the connecting elements (11, 12) in the fiber-reinforced body (9).

### FIELD OF THE INVENTION

The present invention relates to a torsionally elastic coupling with a plurality of radially deflectable springs distributed over the periphery for transmission of torque between a hub and an outer crown, whereby the springs comprise a fibre-reinforced body bent at least once about an axis of curvature parallel to the axis of rotation of the coupling and exhibiting connecting elements for attaching the hub or outer crown.

### DESCRIPTION OF THE PRIOR ART

Such couplings permit relative movements between a driven element and a drive element, such as axial, radial and angled offset, as in EP 551 552 A2. But these couplings have a flat damper, requiring the use of additional torsional vibration dampers so as not to unnecessarily stress a drive string-with vibrations.

Other known couplings to date have mostly been fitted with steel springs which are clamped from individual spring leaves or as a spring leaf package with interleaving of spacers inside a tension ring forming the outer crown or belonging to the outer crown and engage with their free inner ends in grooves of the hub. This results in corresponding manufacturing and structural expense and the coupling is barely capable of equalising radial displacements of the components to be joined together. Damping of the resulting torsional vibrations also requires special measures such as forming fluid-filled damping chambers between the spring elements and the spacers clamping the spring elements, further increasing the structural expense of the couplings.

### SUMMARY OF THE INVENTION

The object of the invention is therefore to create a torsionally elastic coupling of the type described at the outset, which is distinguished by a comparatively simple structure by its displacement capacity and its damping properties.

The invention solves this task by the fact that at least one longitudinally extending elastomer layer is embedded between the connecting elements in the fibre-reinforced body. These springs can be screwed by their connecting elements to suitable flange rings of the hub on the one hand and on the other hand can be screwed to outer crowns of any shape, whether these are inherent outer crowns, or annular areas serving as outer crowns, of flywheels or the like of the components to be coupled, and owing to the material properties of the fibre-reinforced body contribute the desired torsional elasticity on the one hand and the vibrational damping on the other hand. Without any additional measures they also allow the known equalising of axial, radial and angular axle displacement of the components to be coupled to one another. The result thereof is a very simple, space-saving and effectively structural coupling whose elasticity and displacement capacity can be influenced by the shaping and the fibre-reinforced material of the spring body. The elastomer layer embedded in the fibre-reinforced body is transverse stressed with the bending motion of the fibre-reinforced body, such that the damping properties peculiar to the elastomer are useful for vibration damping. At the same time the achievable damping characteristic is influenced purposefully by the choice of elastomer, the number of elastomer layers and their course.

If the fibre-reinforced body comprises fibre-reinforced layers of varying properties, glass or carbon fibre-reinforced layers for example, arranged symmetrically to the middle elastomer layer, the employed fibre-reinforced materials are used optimally relative to their material properties. When the springs are bent, zones of high pressure stress and tensile stress, with approximately neutral zones in between, result on both sides on the middle elastomer layer in the vicinity of the elastomer laver and on the outer sides of the fibre-reinforced body, such that fibre-reinforced layers with low-elastic material, carbon fibre synthetic material for example, can be used for the neutral zones and fibre-reinforced layers with high-elastic material, glass fibre synthetic material for example, can be used for the stressed zones. Corresponding layout of the layer thicknesses gives rise to load ratios and produces the maximum permissible tension of the edge fibres in the respective fibre-reinforced layers when the springs are bent to their maximum and thus allow optimising of the use of material.

In order to increase the axial displacement capacity of the coupling in a simple manner, the fibre-reinforced body can present at least one slot running in a normal plane to the coupling axis in the region between the connecting elements, which is why the mobility of the springs is accordingly increased in the axial direction.

### BRIEF DESCRIPTION OF THE DRAWING

The inventive object is illustrated diagrammatically in the diagram, in which:

FIGS. 1 and 2 show a torsionally elastic coupling according to the present invention in an axially normal cross-section along line I-l of FIG. 2 or in axial section along line II-II of FIG. 1,

FIG. 3 shows a somewhat modified embodiment of this coupling in axial section according to FIG. 2, and

FIG. 4 shows the structure of a spring of this coupling in an axially normal longitudinal section on an enlarged scale.

### DESCRIPTION OF THE PREFERRED EMBODIMENT

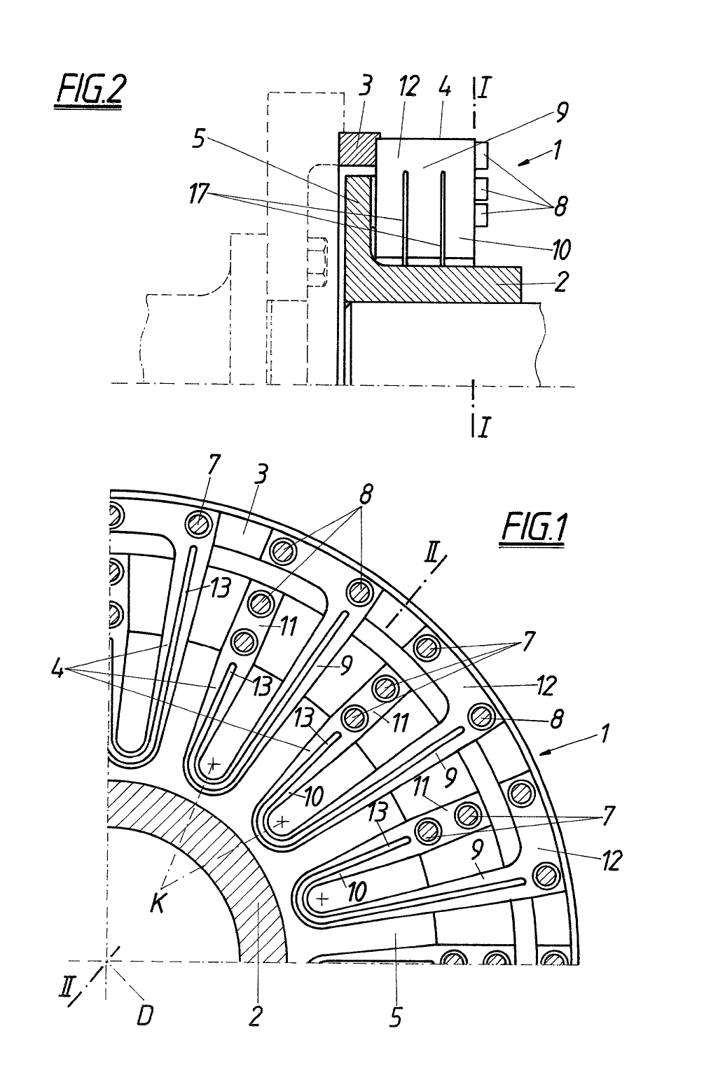

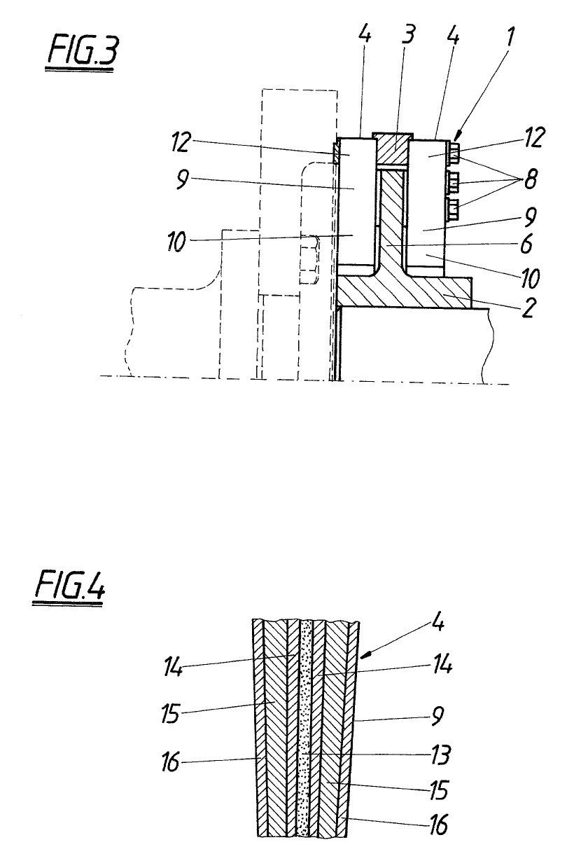

A torsionally elastic coupling 1 is equipped with a plurality of radially deflectable springs 4 distributed over the periphery for transmission of torque between a hub 2 and an outer crown 3, whereby on the one hand the springs are screwed to an end flange 5 of hub 2 (FIG. 2) or in a paired arrangement of springs 4 are screwed to an annular flange 6 of hub 2 (FIG. 3) and on the other hand are screwed to outer crown 3 by use of steel collets 7 and appropriate fasteners 8. In the process outer crown 3 can be an inherent crown component as a mounting auxiliary, as in FIGS. 2 and 3, but can also be a direct annular region of the component to be coupled, a flywheel for example.

Springs 4 comprise a fibre-reinforced body 9 which forms a middle section 10 bent somewhat in a U-shape at least once about an axis of curvature K parallel to axis of rotation D of the coupling and two end connecting elements 11, 12 with steel collets 7 for attachment to the hub or outer crown, whereby at least one elastomer layer 13 extending longitudinally and embedded in middle section 10. Said springs 4 not only allow corresponding transmission of torque between hub 2 and outer crown 3, but also offer the possibility of axial, radial and angled displacement on account of their shaping and their fibre-reinforced material, and also offer damping of vibration by way of elastomer layer 13.

In order to optimise the springs with respect to the employed fibre-reinforced material fibre-reinforced body 9 comprises fibre-reinforced layers 14, 15, 16 of varying elastic properties, arranged symmetrically to the middle elastomer layer, whereby fibre-reinforced layers 14 made of a higher elastic material, glass fibre-reinforced layers for example, are attached directly to elastomer layer 13, followed by middle fibre-reinforced layers 15 made of a less elastic material, carbon fibre-reinforced layers for example, and again fibre-reinforced layers 16 made of a higher elastic material, glass fibre-reinforced layers, are provided on the outside. In this way these fibre-reinforced layers are matched to the respective load ratios when the springs are bent and fibre-reinforced layers 15 made of less elastic material are used in the neutral bending zones, while the fibre-reinforced layers of a higher elastic material are used in stress-intensive fibre-reinforced layers 14, 16, such that the fibres of the layers can be fully utilised with respect to their tensile properties.

In order to increase the axial displacement capacity of the coupling in a simple manner, fibre-reinforced bodies 9 of springs 4 present slots 17 running in a normal plane N to coupling axis D in the region of middle section 10 such that springs 4 can better match axial offset of the components to be coupled and thus match axial offset between hub 2 and outer crown 3

1. A torsionally elastic coupling having a plurality of radially deflectable springs distributed over the periphery for transmission of torque between a hub and an outer crown, whereby the springs comprise a fibre-reinforced body bent at least once about an axis of curvature parallel to the axis of rotation of the coupling and exhibiting connecting elements for attaching the hub or outer crown, characterised in that at least one longitudinally extending elastomer layer (13) is embedded between the connecting elements (11, 12) in the fibre-reinforced body (9),

2. Coupling as claimed in claim 1, characterised in that the fibre-reinforced body (9) comprises fibre-reinforced layers (14, 15, 16) of varying properties, glass or carbon fibre-reinforced layers for example, arranged symmetrically to the middle elastorner layer (13).

3. Coupling as claimed in claim 1 or 2, characterised in that the fibre-reinforced, body (9) presents at least one slot (17) running in a normal plane (N) to the coupling axis (D) in the region between the connecting elements (11, 12).
